(19) United States
(12) Patent Application Publication
(10) Pub. No.: US 2023/0373803 A1
(43) Pub. Date: Nov. 23, 2023

(54) LITHIUM RECOVERY FROM PRECIPITATED SOLIDS

(71) Applicant: Schlumberger Technology Corporation, Sugar Land, TX (US)

(72) Inventors: Dominic Vincent Perroni, Sugar Land, TX (US); Florence Binet, Houston, TX (US); Rod William Shampine, Sugar Land, TX (US); Prasanna Nirgudkar, Sugar Land, TX (US)

(21) Appl. No.: 18/320,259

(22) Filed: May 19, 2023

Related U.S. Application Data
(60) Provisional application No. 63/365,028, filed on May 20, 2022.

(51) Int. Cl. C01D 15/08; C01D 15/02; C22B 26/12

(52) U.S. Cl. CPC C01D 15/08; C01D 15/02; C22B 26/12

(57) ABSTRACT

Described herein are methods of recovering target ions from salt deposits. The methods include dissolving a target ion from a salt deposit to form a target solution and extracting the target ion from the target solution using a selective extraction process to yield a concentrate of the target ion which can be converted to a product.

### CROSS-REFERENCE TO RELATED APPLICATIONS

This patent application claims benefit of U.S. Provisional Patent Application Ser. No. 63/365,028 filed May 20, 2022, which is entirely incorporated herein by reference.

### FIELD

This patent application describes methods and apparatus for recovery of target ions from aqueous sources. Specifically, processes for recovering target ions such as lithium, nickel, cobalt, manganese, and magnesium from precipitated solids of evaporation processes are described.

### BACKGROUND

Critical minerals are essential components in many carbon-reduced or carbon-neutral technologies. For example, lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

Supply of many target ions is currently forecast to run behind demand, and prices for many target ions currently outstrip even the most optimistic forecasts. While prices are quite volatile as the global market develops, target ion prices are expected to remain high through 2030. The incentive for more target ion production could not be clearer.

Target ions may be recovered from brines. Precipitation from brine by atmospheric evaporation of water has been the most common method of recovering many target ions, particularly lithium. For example, regarding lithium, a lithium-bearing aqueous stream is provided to a large shallow pool where water is evaporated over many months to yield a concentrated lithium solution. Lithium is among the most soluble ions in water, so lithium salts tend to remain in solution after other salts, such as sodium, potassium, calcium, and magnesium salts, have precipitated from solution. These precipitated solids are often removed from a concentrated lithium-bearing brine so that the final lithium salt solution has a minimal amount of other metals. The process of precipitating salts, however, often results in significant lithium loss into the precipitated solids. By some estimates, conventional evaporation processes recover, on average, only 40% of lithium in feed streams. Critical minerals being increasingly precious commodities, effective and efficient methods and apparatus for recovering valuable lithium, and other target ions, from evaporation byproducts are needed.

### SUMMARY

Embodiments described herein provide a method, comprising dissolving a target ion from a salt deposit to form a target solution solution; and extracting the target ion from the target solution using an extraction process selective for the target ion to yield a concentrate.

Other embodiments described herein provide a method that includes dissolving lithium from a salt deposit to form a lithium solution; concurrently extracting lithium from a lithium source in an extraction stage of a lithium-selective extraction process to form a lithium intermediate by contacting the lithium source with a lithium-selective material to remove lithium from the lithium source and unloading lithium from the lithium-selective material using a stripping material to form the lithium intermediate; and converting lithium obtained from the lithium intermediate and the lithium solution to a lithium product.

### BRIEF DESCRIPTION OF THE DRAWINGS

FIG. 1 is a schematic process diagram of a lithium recovery process, according to one embodiment.

FIG. 2 is a schematic process diagram of a lithium recovery process, according to another embodiment.

### DETAILED DESCRIPTION

Salt deposits are frequently recovered from evaporative purification processes, such as evaporative lithium recovery processes that have the objective of separating and purifying lithium salts from other salts. The salt deposits can be target products, in some cases, or byproducts. As noted above, these deposits often contain significant amounts of lithium. A lithium-selective extraction process can be used to recover the lithium trapped in salt deposits from evaporative processes.

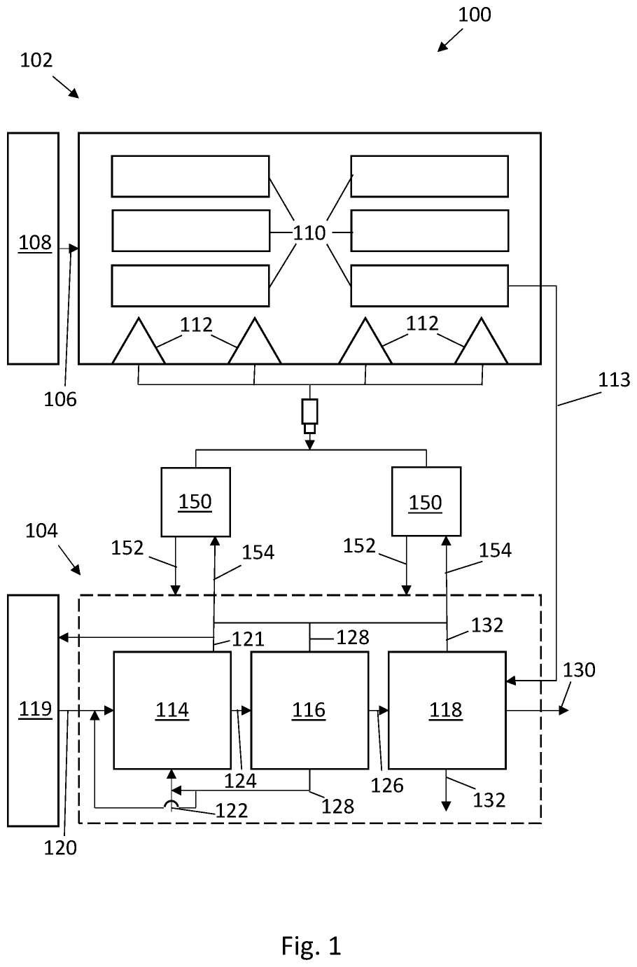

FIG. 1 is a schematic process-flow diagram of a lithium recovery process 100 according to one embodiment. The lithium recovery process 100 includes an atmospheric evaporation process 102 and a lithium-selective recovery process 104. In the atmospheric evaporation process 102, a lithium-bearing aqueous stream 106 from an aqueous lithium source 108 is routed to a plurality of evaporation pools 110. The evaporation pools 110 are shallow catchments where water is allowed to evaporate into the atmosphere to concentrate the salts in the catchments. The salts precipitate in the pools 110 and are recovered.

The pools 110 are typically operated in a sequential fashion to provide separation of lithium from other precipitates. Because the salts precipitate according to their solubility limits, lithium, having substantially the highest solubility in water of the major cations found in most natural water sources, tends to remain in solution after other salts precipitate, although some small amounts of lithium solids can precipitate during evaporative processes. In evaporative lithium recovery processes, to achieve a final product with maximum lithium content, the lithium-bearing aqueous stream 106, obtained from the aqueous lithium source 108, is allowed to evaporate for a period of time in a first pool 110 to precipitate a byproduct salt. The remaining solution is decanted to a second pool while the byproduct salt is removed to a salt deposit 112. This process is repeated as many times as necessary to remove the non-lithium ions from the solution, each time producing a byproduct salt that is removed to the salt deposit. In a final pool 110, a lithium concentrate solution is produced that can be further refined on or offsite, if desired, into other lithium products such as lithium carbonate and lithium hydroxide.

The salt deposit 112 is commonly maintained as one or more piles of salt, which can sit in open air or be housed in any convenient way. As noted above, the salt deposit 112 contains a significant quantity of lithium that can be recovered using the lithium-selective extraction process 104. Lithium can be lost in evaporation processes due to minor amounts of lithium precipitation, as referred to above, or due to impregnation of lithium solution into precipitated solids, and other known mechanisms, such as the formation of double salts.

The lithium-selective extraction process 104 generally has an extraction stage 114, a purification stage 116, and a conversion stage 118. In the extraction stage 114, an extraction stage feed 120, obtained from an aqueous lithium source 119, which can be the same source as the aqueous lithium source 108, or a different source, is contacted with a lithium-selective material to remove lithium from the feed 120. The lithium-selective material can be solid or liquid. Contacting the feed 120 with the lithium-selective material results in a loaded lithium-selective material and a depleted aqueous material 121. The lithium depleted aqueous material 121 can be returned to the environment as a reject stream, and may be purified or have its pH adjusted before being returned to the environment. The depleted aqueous material 121 can also be used in the processes 102 and 104 in other ways, as described below.

A stripping material 122 is used to unload lithium from the lithium-selective material. The stripping material is an aqueous stream that may be water, a brine solution, an acidic solution, and acidic brine solution, a buffer solution, or another material selected to remove the lithium from the lithium-selective material. The stripping material may be selective to lithium so that lithium is removed from the lithium-selective material at a higher proportion than impurity materials. In most cases, the stripping material will be water or brine, and may be sourced from other units of the lithium-selective process 104.

Removing lithium from the lithium-selective material in the extraction stage 114 yields a lithium intermediate stream 124 that is routed to the purification stage 116. In the purification stage 116, the concentration of lithium is typically increased and the concentration of any impurities is reduced, or at least increased by a proportion less than that of lithium. The purification stage 116 can include any mixture of, ion exchange processes, filtration processes, osmotic processes, evaporation processes, redox processes (including electrochemical processes), and solids removal processes to remove water and impurities from the lithium intermediate stream 124. For instance, the purification stage 116 may include one or more of the following operations: impurity precipitation, solids removal and divalent impurity selective removal followed by lithium concentration (i.e. water removal). The impurity precipitation may comprise coagulation-flocculation. The divalent impurity selective removal may comprise a selective electrochemical separation process, which may utilize an impurity selective membrane, and/or a divalent impurity capture using an ion exchange resin. One embodiment of the purification process includes routing the stream derived from the lithium intermediate (i.e. lithium intermediate or a derivative thereof) to an impurity precipitation operation that uses coagulation-flocculation to yield a precipitate stream, routing the precipitate stream or a derivative thereof to solids removal to yield a filtered precipitate stream and a precipitate and routing the filtered precipitate stream or a derivative thereof to the divalent impurity selective removal to yield the purified stream. The purified stream can then be concentrated, where any membrane separation process (including counter-flow reverse osmosis, reverse osmosis or a combination thereof) may be used. Enhanced or mechanical evaporators may be used as well. The resulting lithium concentrate may have a TDS (total dissolved solids) over 120,000 mg/l preferably over 200,000 mg/l.

A lithium concentrate stream 126 is produced by the purification stage 116 along with one or more removed streams 128. The removed streams 128 are generally aqueous streams that can have lithium and elevated levels of impurities such as sodium, potassium, calcium, and magnesium or could be a stream with extremely low total dissolved solids (ionic or organic). The lithium is the removed streams 128 is sometimes recovered, at least partially, by returning some of all of the removed streams 128 to the extraction stage 114. Depending on the concentration of impurities and lithium in the removed streams 128, all or part of the removed streams 128 can be used as, or included in, the stripping material 122. Additionally or instead, all or part of the removed streams 128 can be mixed with the extraction stage feed 120 to re-process the removed streams 128 in the extraction stage 114.

The lithium concentrate stream 124 is routed to the conversion stage 118 where lithium chloride is converted to lithium hydroxide by treatment with calcium hydroxide, or to lithium carbonate by treatment with sodium carbonate, or both. The conversion stage 116 which may include processes to maximize lithium concentration, before and/or after conversion, produces a lithium product 130, which is hydroxide, carbonate, or both, and an aqueous byproduct 132 that is usually mostly water and sodium chloride, but may include some unreacted hydroxide and/or carbonate ions. The aqueous byproduct 132 can be routed to disposal or re-used in the process 104. For example, where concentration of lithium streams in the conversion stage 116 results in lithium being separated into the byproduct 132, the byproduct can be routed to the purification stage 116 or to the extraction stage 114. Where the byproduct 132 contains unreacted hydroxide and/or carbonate, those can be neutralized, if necessary, by appropriate treatments (HCl to neutralize OH⁻ and CaCl₂) to precipitate CO₃²⁻). Unreacted hydroxide and/or carbonate can also be recycled internally within the conversion stage 118.

In this case, salt from the salt deposit 112 is added to the lithium-selective extraction process 104 for recovery. The salt is routed to one or more contactors 150 to prepare a reclaimed salt solution 152, which is routed to the process 104. All or part of the reclaimed salt solution 152 can be routed to the extraction stage 114 independently from the extraction stage feed 120 or mixed with the extraction stage feed 120. For example, the reclaimed salt solution 152 can be used to adjust the composition and/or other properties, such as pH and temperature, of the extraction stage feed 120.

The reclaimed salt solution 152 is made by contacting salt from the salt deposit 112 with an aqueous stream 154. The aqueous stream 154 can be water, recycled salt solution from the process 104, or both, or a mixture thereof. Here, the aqueous stream 154 is shown as a recycled solution from the process 104. Typically, to avoid unnecessary impurity loading, enough aqueous medium is contacted with the salt in the contactors 150 to dissolve the lithium from the salt while minimizing uptake of other salts into the reclaimed salt solution 152. An ion analyzer can be coupled to the reclaimed salt solution stream 152 to report lithium quantity in the stream. The contactors 150 can be operated to yield a reclaimed salt solution 152 that has lithium content just below saturation to ensure water is used most efficiently. Depending on the composition of the salt deposit 112, the resulting reclaimed salt solution 152 can have a wide range of compositions. For example, where the salt deposit 112 is higher in lithium content, the reclaimed salt solution 152 can have more lithium. Such a stream could be routed directly to the purification stage 116. Alternately, or additionally, such a reclaimed salt stream could be mixed with the extraction stage feed 120 to increase concentration of lithium in the extraction stage feed 120.

It can be helpful to use a material for the aqueous stream 154 that is selective for dissolving lithium. While water is selective for lithium simply by virtue of higher solubility of lithium in water than other ions, using an aqueous stream already loaded with impurity ions such as sodium and calcium, and having low or no lithium content, effectively provides selectivity for lithium because the aqueous stream has reduced capacity to dissolve more impurity ions. If the aqueous stream is saturated with impurity ions and not lithium, it will only absorb lithium from the salt deposit 112. Various returned or removed streams from the lithium-selective extraction process 104 have moderate to high levels of impurities with little or no lithium content. Where these streams would normally be returned, reused, or recycled within the process 104, such streams can also be used to selectively reclaim lithium from the salt deposit 112. Streams such as the depleted aqueous material 121, the removed stream 128, and the byproduct 132 can be used

The contactors 150 can be any convenient type of contactor, such as a mixing tank or a bed-type contactor (i.e. fixed or fluidized with liquid flowed through or sprayed on). Where only enough aqueous medium is used to dissolve the lithium in the salt deposit 112, a salt slurry or wet bed of undissolved solids remains and is sent to disposal. Alternately, the entire salt deposit 112 can be dissolved in aqueous medium and routed through the process 104 to bring all the salts from the salt deposit 112 into the various output streams of the lithium-selective extraction process 104.

In some cases, a solvent can be directly applied to a salt pile to form the reclaimed salt solution 152. A collection system can be provided beneath a salt pile. For example, screens, liners, and other containment structures, including fluid connection tanks and piping to deliver fluids to the process 104, can be configured prior to forming a salt pile on the containment structures. Bores, horizontal, vertical, and/or sloped, can be formed in the salt pile to enhance fluid flow through the pile. The pile can also be shaped to enhance fluid contact with the solids of the pile. For example, the top of the pile can be maintained in a concave shape to provide a leaching pool at the top of the pile to flow through the solids to the bottom of the pile or the salt pile could be positioned on a semi permeable surface to aid in draining.

The processes 102 and 104 can be used to recover lithium salts without having to add make-up fresh water to either process. Careful use, re-use, and rejection of brine streams of the lithium-selective extraction process 104 is typically effective to minimize or prevent incremental handling of water. For example, minimizing bringing impurities from the salt deposit 112 into the process 104 reduces the need for additional water to motivate those impurities through the process 104. Likewise, rejecting impurities at carefully selected compositions can help maintain water balance in the process 104. Ion analyzers can be deployed throughout the process 104 to monitor compositions, while flow meters monitor flow rates. A controller can receive signals representing flow rates and compositions of the various streams of the process 104 and can monitor the material balance of the process 104 and adjust the flow rates and process conditions to maintain water balance. The controller can be provided with a model of the process 104 to enable the controller to select control actions to take to maintain water balance, along with lithium product purity, depending on composition of input streams. The extraction stage 114 can be configured with variable capacity to provide a separation control parameter to adjust how the process 104 separates lithium, impurities, and water for maximum efficiency.

The atmospheric evaporation process 102 produces a lithium rich solution product, of which the dissolved material is mostly lithium chloride, and potentially with smaller amounts of other dissolved lithium salts. It should be noted that the liquor from the final evaporation pool 110 that is used to produce the concentrated lithium product, or the concentrated lithium product itself, can also be provided, as a lithium concentrate stream 113, to the purification stage 116 or the conversion stage 118 of the lithium-selective extraction process 104 for conversion to the lithium product 130. The lithium concentrate stream 113 can be further concentrated separately rather than adding the full water volume of the lithium concentrate stream 113 to the process 104.

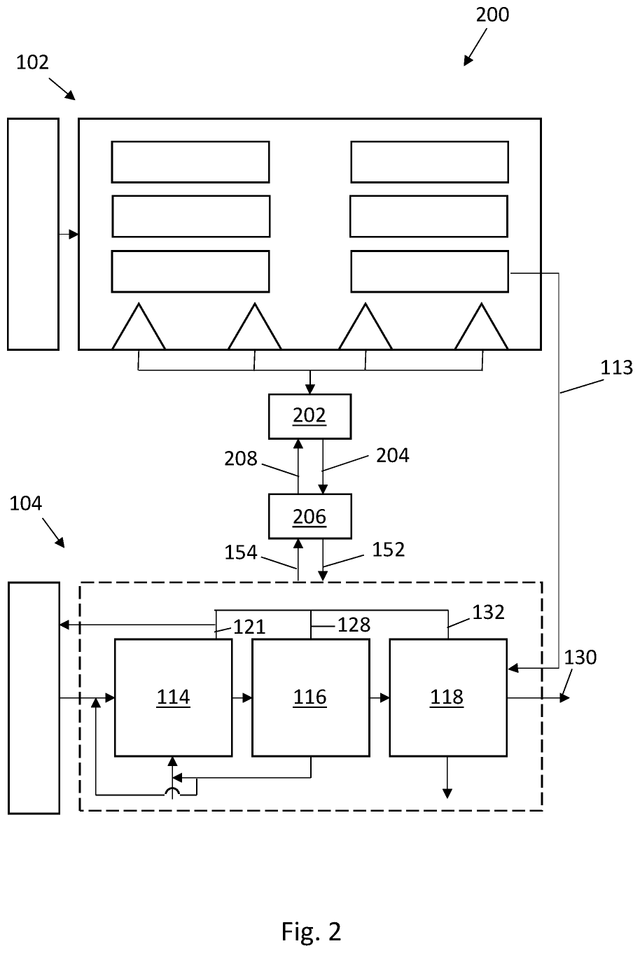

FIG. 2 is a schematic flow diagram of a lithium recovery process 200 according to another embodiment. The process 200 is similar in many ways to the process 100. The chief difference between the process 200 and the process 100 is that the process 200 uses an organic lithium-selective solvent for reclaiming lithium from a salt deposit and segregates the organic solvent from the lithium-selective extraction process 104. A solvent such as 1-butanol, 2-butanol, 1-propanol or 2-propanol can be used to selectively dissolve lithium from the salt deposit 112. These solvents typically have solubility selectivity of Li to Na of around 20:1 by mass. Other organic solvents, such as methanol, ethanol, 1-butanol, 2-butanol, 1-propanol, and 2-propanol, formic acid, N-methylformamide, hydrazine, tetrahydrofuran, beta-diketones\organophosphrous compounds, crown ethers, and certain ionic materials such as Lithium bis(trifluoromethanesulfonyl)imide, 1-butyl-3-methyl-imidazolium hexafluorophosphate, tetrabutylammonium mono-2-ethylhexyl-(2-ethylhexyl) phosphonate, tetrabutylammonium bis(2-ethylhexyl)phosphate, tetrabutylammonium bis(2-ethylhexyl)phosphinate, tetrabutylammonium diisooctylphosphinate, N-butyl pyridinium bis((trifluoromethyl)sulfonyl)imide also have substantial selectivity for dissolving Li rather than Na. Mixtures of such solvents can also be used.

Selection of the organic lithium-selective solvent should be done in terms of toxicity, flammability, ability to release the lithium, and the ability to recover the remaining solvent from the solids. Saturated sodium chloride (or other salt) brine may be used as a carrier or extender for the solvent to facilitate mechanical action or to improve later removal of the loaded solvent. When brine is used a non-miscible solvent may be more attractive in that it is more readily separated from the brine. Alternatively, where a miscible lithium selective solvent is employed the resulting saturated brine plus solvent may be separated and then diluted to allow Lithium to transfer from the solvent to the brine where it is more readily recovered in the lithium-selective extraction process 104. It can be useful to minimize the amount of organic solvent transferred to the process 104 to minimize solvent losses and hazards associated with processing using organic solvents. Organic solvents for the process 200 can be chosen to minimize such hazards.

Solid salt is contacted with the solvent in a contactor 202, which can be a mixing tank or a bed-type contactor as described above. A loaded solvent stream 204 exits the contactor 202 loaded with lithium and other ions and is routed to a solvent recovery unit 206. Bulk solids can be introduced to the contactor and the solvent applied while the solids are fixed in place or fluidized, for example by mechanical mixing. The solids can be ground to ensure internally-retained lithium is released from the solids. The solvent, or the solvent-solid mixture, can be heated to improve extraction of lithium.

In the solvent recovery unit 206, the organic solvent is removed, recovered, and returned to the contactor 202 as a solvent stream 208. The organic solvent can be removed generally by evaporation, and recovered by condensation. Prior to evaporation, solids can be separated from the loaded solvent using mechanical means. Evaporation of the organic solvent from wet solids yields solid salts of lithium and other elements, which can be dissolved in the aqueous stream 154 to form a reclaimed salt solution 152 and provided to the lithium-selective extraction process 104. To minimize adding organics to the aqueous process 104, the dry salts can be heated to drive off any adsorbed or trapped organic species. Such heating can be performed under reduced pressure or vacuum to enhance organics removal. Removed organics can be added to the recovery condensation process for recycle back to the contactor 202. Trace organics can also be removed from the reclaimed salt solution 152 by passing the reclaimed salt solution 152 through a granulated activated carbon filter.

The processes 100 and 200 can be water balanced by adding make-up water to any convenient location of the process. The water balance of the process can be monitored using composition analyzers and flow meters at selected locations of the process to monitor water flux. For example, water enters the process 104 in the extraction stage feed 120, the reclaimed salt stream 152, the stripping material 122, and the lithium concentrate stream 113. Water exits the process 104 in the aqueous stream 154, the depleted stream 121, the byproduct 132, and potentially the lithium product 130. These streams can be monitored using a control system to ascertain trending of the water balance, whether upward or downward. Locations of the process 104 that may be operated in a water-starved state can be monitored to ascertain whether water should be added or removed from the process. For example, it may be advantageous to concentrate aqueous streams in the purification stage 116 to an impurity solubility limit before performing a precipitation reaction, or beyond the impurity solubility limit to directly precipitate impurities. Such concentration steps can be monitored for energy input or volume of water removed to adjust the overall water balance of the process 104 using a control system configured for such purposes. For example, if volume of water removed to obtain a target residual impurity level is increasing, after adjusting for any change in relative concentration of lithium and impurities, water removal from the process 104 can be increased, for example by directing more of the depleted stream 121 or the byproduct stream 132 to the environment, or water make-up to the process 104 can be decreased, for example by decreasing flow of the stripping material 122 into the extraction stage 114.

The apparatus described herein enable performance of a method of recovering lithium by evaporating water from an aqueous lithium source in an atmospheric evaporation process to yield solid salts, dissolving lithium from the solid salts in an aqueous medium to form a reclaimed salt solution, and providing the reclaimed salt solution to a lithium-selective extraction process to recover the lithium from the reclaimed salt solution. Aqueous streams from the lithium-selective extraction process that have enhanced lithium selectivity due to prior impurity loading can be used to dissolve lithium from the salt deposit 112, potentially with very high selectivity, and can be directly reused in the lithium-selective extraction process. Other lithium-selective organic solvents, or solvents having organic components, as noted above, can be used to reclaim lithium from the solid salts. The organic solvents can be removed by evaporation using heat, reduced pressure, or both, can be recycled to reclaim more lithium from the solid salts, and can be replaced with water or another aqueous stream to carry the lithium to the lithium-selective extraction process. Trace organics remaining after evaporation can be removed by heating and/or filtration using filter materials, such as granulated activated carbon, that remove organics.

The lithium-selective extraction process performs an extraction process, a purification process, and optionally a conversion process to yield a lithium product. The extraction process uses a lithium-selective medium to withdraw lithium from a lithium-bearing aqueous stream into or onto the medium to yield a lithium-depleted stream. A stripping material is contacted with the loaded medium to remove the lithium from the loaded medium, yielding an aqueous lithium intermediate. The extraction process can yield a large increase in concentration of lithium from a low concentration in the feed to the extraction process, in some cases as low as 70 ppm, to an intermediate concentration, for example 8,000 to 10,000 ppm, in the lithium intermediate. The lithium-selective medium can be liquid or solid, and the contacting can be performed by intimate mixing, fixed bed, or fluidized bed contact. The lithium-depleted stream can be used to reclaim lithium from the solid salts of the atmospheric evaporation process with high selectivity.

The purification process involves further increasing the concentration of lithium and reducing the concentration of impurities. The lithium intermediate is the main feed for the purification process, although a reclaimed salt solution from the atmospheric evaporation process can be blended with the lithium intermediate for purification processing. The purification process uses any combination of filtration, for example membrane filtration, evaporation, and precipitation to remove impurity ions like sodium, potassium, calcium, and magnesium, generally yielding a lithium concentrate stream and an impurity stream. The impurity stream can be used to reclaim lithium from the solid salts of the atmospheric evaporation process. The purification process can provide an increase in lithium concentration of 10-20 times in the lithium concentrate stream relative to the lithium intermediate.

The conversion process involves converting lithium chloride in the lithium concentrate stream to lithium carbonate or lithium hydroxide, generally by reaction with sodium carbonate or calcium hydroxide. In some cases, both products can be made. The conversion process may also involve concentrating lithium further to expedite the conversion reactions. The conversion process generally yields a lithium product, which can be a slurry or dry product of lithium carbonate or lithium hydroxide, or both separate products, along with an aqueous byproduct stream that can contain sodium, trace amounts of potassium, calcium, and magnesium, and unreacted hydroxide and carbonate ions. The aqueous byproduct stream can be used to reclaim lithium from the solid salts of the atmospheric evaporation process. Additionally, an evaporation lithium concentrate from the atmospheric evaporation process can be blended with the extraction lithium concentrate from the purification process for conversion in the conversion process.

In some cases, the lithium-selective extraction process 104 can be used as part of a process to remediate waste salt deposits. The extraction stage feed 120 can be a non-saturated brine drawn from a natural source and directly mixed with solid waste salts from the deposit 112. Such processes generally result in a depleted aqueous stream 121 amplified in non-lithium salt content. Returning such a depleted aqueous stream to the environment can be achieved in a non-impactful way. For example, where the natural source is a saline aquifer, the depleted aqueous stream 121, amplified in non-lithium salt content relative to the general composition of the aquifer, can be returned at a temperature that does not result in scaling or precipitation at reinjection. For example, reinjection depth within the aquifer can be selected such that temperature at the reinjection depth is above a precipitation temperature for the depleted aqueous stream 121.

Where heating is wanted for an individual embodiment of the process 104, the natural lithium source can be derived from a naturally heated source, such as a deep layer of a saline aquifer. Where waste salts are to be added to the natural source, colder sources can be used to support solubility of more waste salts, if desired.

The extraction stage 114, purification stage 116, and optional conversion stage 118 of the lithium-selective extraction process 104 can be located adjacent, one to the other, or one or more of the stages 114, 116, and 118 can be remotely located, one from the other. Thus, representation in the figures of a process boundary of the process 104 is not to be interpreted as a physical boundary or geographic boundary. Likewise, the lithium-selective extraction process 104 can be located adjacent to the evaporative process 102, or can be located remote from the evaporative process 102.

It should be noted that the purification stage 116 is a stage that generally increases concentration of target ions and reduces concentration of impurity ions. As such, the purification stage 116 can utilize any process that achieves such results, including evaporation, driven by direct solar energy or other application of energy, separation using selective separation media, filtration using membranes or other filtration methods, which may also be selective, reaction (i.e. conversion) to precipitate impurities or otherwise remove or increase removability of the impurities, solids removal, osmosis and reverse osmosis processes of any suitable configuration (including counter-flow processes), which can be staged, and other suitable processes. The purification stage 116 can be supplemented by other impurity treatment and/or concentration processes, which can be upstream of the extraction stage 114 or downstream of the extraction stage 114.

The lithium-selective processes described herein can be used to extract, concentrate, and purify other elements, such as nickel, manganese, magnesium, and cobalt. Generally, where the processes herein are described as lithium-selective, materials can be used to make the same processes selective for other target ions, such as those listed above. In such cases, a fluid selective for the target ion is used to dissolve the target ion from a salt deposit. A fluid can be made selective for any target ion by selectively saturating an aqueous stream in ions other than the target ion so that the aqueous stream will selectively dissolve the target ion. Selectivity of the fluid can also be controlled or adjusted by setting temperature of the fluid, since solubility of ions in fluids generally changes with temperature of the fluid. Other solvents can also be used that may be selective for the target ion. The resulting target solution can then be subjected to an extraction process and/or impurity removal process that is substantially the same as the processes described herein, but using materials selective for the target ion to extract, concentrate, and purify the target ion by removing impurities without removing the target ion.

Thus, as described herein, the atmospheric evaporation recovery process that produces the salt deposit can produce an evaporation concentrate that is rich in any target ion, and such concentrate can be used to make, or blended with, an extraction concentrate rich in the same target ion by virtue of an extraction process selective for the target ion.

Embodiments described herein relate to a method, comprising dissolving a target ion from a salt deposit to form a target solution; and extracting the target ion from the target solution using an extraction process selective for the target ion to yield a concentrate.

The method may further comprise converting the target ion in the concentrate to a product.

The target ion may be lithium, nickel, manganese, cobalt, iridium, magnesium or other element used in the manufacturing of energy storage or energy generation devices. In an embodiment, the target ion is lithium.

In an embodiment, converting the lithium in the concentrate to a product is performed in a conversion stage of the extraction process.

In an embodiment, dissolving the lithium from the salt deposit comprises contacting the salt deposit with a solvent or fluid selective for the target ion. In such embodiment, where the target ion is lithium, the solvent may be an organic solvent or a solvated organic molecule. For instance, the solvent is an alcohol. For instance, the solvent is selected from the group consisting of methanol, ethanol, 1-butanol, 2-butanol, 1-propanol, 2-propanol, formic acid, N-methylformamide, hydrazine, tetrahydrofuran, a beta-diketones, an organophosphrous compound, a crown ether, lithium bis(trifluoromethanesulfonyl)imide, 1-butyl-3-methyl-imidazolium hexafluorophosphate, tetrabutylammonium mono-2-ethylhexyl-(2-ethylhexyl) phosphonate, tetrabutylammonium bis(2-ethylhexyl)phosphate, tetrabutylammonium bis(2-ethylhexyl)phosphinate, tetrabutylammonium diisooctylphosphinate, N-butyl pyridinium bis((trifluoromethyl)sulfonyl)imide, or a combination thereof. In such embodiment where the target ion is lithium, the solvent may have a selectivity of lithium to sodium of about 20:1 by mass.

The method may further comprise concurrently extracting the target ion from a source containing the target ion using the extraction process.

In an embodiment, dissolving target ion from the salt deposit comprises providing salt from the salt deposit to a contacting vessel and routing an aqueous stream from the extraction process to the contacting vessel. In such embodiment, the aqueous stream comprises an impurity stream from the extraction process. The aqueous stream may be a deionized water stream from the extraction process.

Dissolving the target ion from the salt deposit may comprise contacting the salt deposit with a fluid selective for the target ion comprising a stream from the extraction process.

The salt deposit may be a waste salt deposit. In an embodiment, the salt deposit is a waste salt deposit from an evaporation process, and the method is part of a process to remediate the waste salt deposit.

In an embodiment, extracting the target ion from the target solution using an extraction process selective for the target ion also yields a depleted stream, which is depleted of the target ion, and further comprising returning the depleted stream to the environment. In such embodiment, returning the depleted stream to the environment may comprise injecting the depleted stream underground at a depth selected such that a temperature at the depth is above a precipitation temperature of the depleted stream.

In an embodiment, the concentrate is an extraction concentrate, the salt deposit is a byproduct of an atmospheric evaporation recovery process that yields an evaporation concentrate; and the method further comprises converting target ions in the evaporation concentrate and the extraction concentrate to a product.

In such embodiment, the dissolving the target ion from the salt deposit may comprise contacting the salt deposit with an aqueous stream from the extraction process.

In an embodiment, where the target ion is lithium, the product may be lithium carbonate, lithium hydroxide, lithium chloride, lithium sulfate, lithium metal, or any combination thereof.

In an embodiment, extracting the target ion using the selective extraction process includes contacting the target solution with a material selective for the target ion to remove the target ion from the target solution and unloading the target ion from the selective material using a stripping material to form an intermediate.

In an embodiment, extracting the target ion from the target solution using an extraction process selective for the target ion to yield a concentrate wherein the extraction process yields an intermediate, and wherein extracting further includes a purification process to yield the concentrate from the intermediate, wherein the purification process includes one or more of water removal and impurity removal. The purification stage may include an ion exchange process, a filtration processes, an osmotic process, an evaporation process, a redox process, an electrochemical processes, a solids removal process, an enhanced or mechanical evaporation process, or any combination thereof. In a specific embodiment, the purification stage includes a water removal stage using a reverse osmosis process, counter-flow reverse osmosis process or any combination thereof. In particular, such water removal stage may be configured so that the TDS of the lithium concentrate is above 120,000 mg/l.

In an embodiment, dissolving the target ion from the salt deposit comprises contacting the salt deposit with a fluid and controlling selectivity of the fluid for dissolving the target ion by setting a composition, temperature, or both, of the fluid.

The disclosure also relates to a method including dissolving lithium from a salt deposit to form a lithium solution; concurrently extracting lithium from a lithium source distinct from the lithium solution in an extraction stage of a lithium-selective extraction process to form a lithium intermediate by contacting the lithium source with a lithium-selective material to remove lithium from the lithium source and unloading lithium from the lithium-selective material using a stripping material to form the lithium intermediate; and converting lithium obtained from the lithium intermediate and the lithium solution to a lithium product.

In an embodiment, dissolving lithium from the salt deposit comprises contacting the salt deposit with a fluid and controlling selectivity of the fluid for dissolving lithium by setting a composition, temperature, or both, of the fluid.

In an embodiment, the method further comprising purifying the lithium intermediate and the lithium solution to form a lithium concentrate and converting lithium of the lithium concentrate to the lithium product, wherein purifying includes one or more of removing water and removing impurities. The purification stage may include an ion exchange process, a filtration processes, an osmotic process, an evaporation process, a redox process, an electrochemical processes, a solids removal process, an enhanced or mechanical evaporation process, or any combination thereof. In a specific embodiment, the purification stage includes a water removal stage using a reverse osmosis process, counter-flow reverse osmosis process or any combination thereof. In particular, such water removal stage may be configured so that the TDS of the lithium concentrate is above 120,000 mg/l.

In an embodiment, the method further comprises monitoring a lithium quantity in the lithium solution and/or a composition of the lithium solution and routing the lithium solution to the extraction stage before the conversion stage based on the lithium quantity and/or composition.

In an embodiment, the salt deposit is a waste salt deposit from an evaporation process, and the method is part of a process to remediate the waste salt deposit.

In an embodiment, dissolving the lithium from the salt deposit comprises contacting the salt deposit with a solvent or fluid selective for lithium. In such embodiment, the solvent may be an organic solvent or a solvated organic molecule. For instance, the solvent is an alcohol. For instance, the solvent is selected from the group consisting of methanol, ethanol, 1-butanol, 2-butanol, 1-propanol, 2-propanol, formic acid, N-methylformamide, hydrazine, tetrahydrofuran, a beta-diketones, an organophosphrous compound, a crown ether, lithium bis(trifluoromethanesulfonyl)imide, 1-butyl-3-methyl-imidazolium hexafluorophosphate, tetrabutylammonium mono-2-ethylhexyl-(2-ethylhexyl) phosphonate, tetrabutylammonium bis(2-ethylhexyl)phosphate, tetrabutylammonium bis(2-ethylhexyl)phosphinate, tetrabutylammonium diisooctylphosphinate, N-butyl pyridinium bis((trifluoromethyl)sulfonyl)imide, or a combination thereof. In such embodiment where the target ion is lithium, the solvent may have a selectivity of lithium to sodium of about 20:1 by mass.

In an embodiment, dissolving lithiuim from the salt deposit comprises providing salt from the salt deposit to a contacting vessel and routing an aqueous stream from the extraction process to the contacting vessel. In such embodiment, the aqueous stream comprises an impurity stream from the extraction process. The aqueous stream may be a deionized water stream from the extraction process.

Dissolving the lithium from the salt deposit may comprise contacting the salt deposit with a fluid selective for the lithium comprising a stream from the extraction process.

In an embodiment, extracting the lithium from the lithium source also yields a depleted stream, which is depleted of the target ion, and further comprising returning the depleted stream to the environment. In such embodiment, returning the depleted stream to the environment may comprise injecting the depleted stream underground at a depth selected such that a temperature at the depth is above a precipitation temperature of the depleted stream.

The product may be lithium carbonate, lithium hydroxide, lithium chloride, lithium sulfate, lithium metal, or any combination thereof.

While the foregoing is directed to embodiments of the present invention, other and further embodiments of the present disclosure may be devised without departing from the basic scope thereof, and the scope thereof is determined by the claims that follow.

We claim:

1. A method, comprising:
dissolving a target ion from a salt deposit to form a target solution; and
extracting the target ion from the target solution using an extraction process selective for the target ion to yield a concentrate.

2. The method of claim 1, further comprising converting the target ion in the concentrate to a product.

3. The method of claim 1, wherein the target ion is lithium, nickel, manganese, cobalt, or magnesium.

4. The method of claim 1, wherein dissolving the target ion from the salt deposit comprises contacting the salt deposit with a solvent or fluid selective for the target ion.

5. The method of claim 1, further comprising concurrently extracting the target ion from a source containing the target ion using the extraction process.

6. The method of claim 1, wherein dissolving the target ion from the salt deposit comprises providing salt from the salt deposit to a contacting vessel and routing an aqueous stream that comprises an impurity stream of the extraction process from the extraction process to the contacting vessel.

7. The method of claim 4, wherein dissolving the target ion from the salt deposit comprises contacting the salt deposit with a fluid selective for the target ion, the fluid comprising a stream from the extraction process.

8. The method of claim 4, wherein the target ion is lithium and the solvent is an organic solvent or a solvated organic molecule.

9. The method of claim 1, wherein extracting the target ion from the target solution using an extraction process selective for the target ion also yields a depleted stream, which is depleted of the target ion, and further comprising returning the depleted stream to the environment.

10. The method of claim 9, wherein returning the depleted stream to the environment comprises injecting the depleted stream underground at a depth selected such that a temperature at the depth is above a precipitation temperature of the depleted stream.

11. The method of claim 1, wherein
the concentrate is an extraction concentrate;
the salt deposit is a byproduct of an atmospheric evaporation recovery process that yields an evaporation concentrate; and
the method further comprises converting target ions in the evaporation concentrate and the extraction concentrate to a product.

12. The method of claim 1, wherein extracting the target ion using the selective extraction process includes contacting the target solution with a material selective for the target ion to remove the target ion from the target solution and unloading the target ion from the selective material using a stripping material to form an intermediate.

13. The method of claim 1, wherein extracting the target ion from the target solution using an extraction process selective for the target ion to yield a concentrate also yields an intermediate, and wherein the extraction process includes a purification process that removes water, impurities, or both to yield the concentrate from the intermediate.

14. The method of claim 1, wherein dissolving the target ion from the salt deposit comprises contacting the salt deposit with a fluid and controlling selectivity of the fluid for dissolving the target ion by setting a composition, temperature, or both, of the fluid.

15. The method of claim 1, wherein the salt deposit is a waste salt deposit from an evaporation process, and the method is part of a process to remediate the waste salt deposit.

16. A method, comprising:
dissolving lithium from a salt deposit to form a lithium solution;
concurrently extracting lithium from a lithium source distinct from the lithium solution in an extraction stage of a lithium-selective extraction process to form a lithium intermediate by contacting the lithium source with a lithium-selective material to remove lithium from the lithium source and unloading lithium from the lithium-selective material using a stripping material to form the lithium intermediate; and
converting lithium obtained from the lithium intermediate and the lithium solution to a lithium product.

17. The method of claim 16, wherein dissolving lithium from the salt deposit comprises contacting the salt deposit with a fluid and controlling selectivity of the fluid for dissolving lithium by setting a composition, temperature, or both, of the fluid.

18. The method of claim 16, further comprising purifying the lithium intermediate and the lithium solution to form a lithium concentrate and converting lithium of the lithium concentrate to the lithium product, wherein the purifying includes removing water, removing impurities, or both.

19. The method of claim 18, further comprising monitoring a lithium quantity in the lithium solution and/or a composition of the lithium solution and routing the lithium solution to the extraction stage before the conversion stage based on the lithium quantity and/or composition.

20. The method of claim 16, wherein the salt deposit is a waste salt deposit from an evaporation process, and the method is part of a process to remediate the waste salt deposit.
